(19) United States
(12) Patent Application Publication
(10) Pub. No.: US 2014/0098386 A1
(43) Pub. Date: Apr. 10, 2014

(54) APPARATUS, METHODS, AND ARTICLES OF MANUFACTURE FOR IMAGE PRINTING, PACKAGING, AND MAILING

(71) Applicant: Ron E. Goade, SR., Scottsdale, AZ (US)

(72) Inventor: Ron E. Goade, SR., Scottsdale, AZ (US)

(21) Appl. No.: 13/646,335

(22) Filed: Oct. 5, 2012

(51) Int. Cl. G06K 15/02

(52) U.S. Cl. 358/1.6

(57) ABSTRACT

A server receives from a user information regarding images. The information may include identification(s), selection(s) and/or uploads of the images. The images are printed on a plastic substrate so that a different portion of the substrate corresponds to a different image. Delivery address, postage, promotions, and other information may also be printed. The printed substrate is laminated. Manually separable articles are then defined on the substrate so that each article has a portion of the substrate with an image. The articles may be defined by perforating or partially die-cutting of the substrate along curves enclosing the articles. The articles may include means for fastening the articles to other objects, such as bracelets, snaps, cords, necklaces, backpacks, shoes, keys and key chains. Before manufacturing, the user may edit the images, and a simulated appearance of the printed substrate may be shown to the user, to obtain the user's approval.

### REFERENCE TO RELATED PATENT APPLICATION

This application claims priority benefit of provisional U.S. Patent Application Ser. No. 61/627,396, entitled PHOTO POGS, filed on 11 Oct. 2011, which application is hereby incorporated, by reference in its entirety, including all figures, tables, claims, listings, and all other matter included therein.

### FIELD OF THE INVENTION

This application relates generally to the field of customizing, printing, packaging, and mailing articles with pictures and/or other information printed on the them.

### BACKGROUND

Printing of photographs and other custom information on charm bracelets has been known for some time. Also known is printing of custom information on membership cards, identification cards, and credit cards. Some of these articles may be sent to a recipient by mail or other delivery services. The articles may be sent inside envelopes or without envelopes, akin to postcards.

There is a need to reduce production costs of customizable articles and their associated mailer packages. There is also a need to reduce the opportunities for mislabeling and misaddressing such articles and packages. There is a further need to make the articles stronger and more durable. There is an additional need to facilitate customization of the articles by customers.

### SUMMARY

Embodiments described in this document are directed to methods, apparatus, and articles of manufacture that satisfy one or more of these and/or other needs.

In an embodiment, a method for providing a mailing piece includes obtaining from a user information sufficient to get one or more images in digital form, for example, receiving from the user identification(s)/selection(s)/uploads of the images. The method also includes printing each image of the one or more images (in a plastic substrate, a different portion of the substrate per different image of the one or more images, resulting in a printed substrate. The method additionally includes laminating, the printed substrate, to obtain a laminated substrate. The method further includes defining in the laminated substrate one or more articles manually separable from the laminated substrate, each article of the one or more articles having a portion of the substrate with the image of the one or more images. Weakening may include perforating or partially die-cutting the laminated substrate.

In an embodiment, a computer system is configured to obtain from a user information sufficient to get one or more images. The computer system is also configured to cause each image of the one or more images to be printed on a plastic substrate, a different portion of the substrate per different image, thereby resulting in a printed substrate. The computer system is additionally configured to cause the printed substrate to be laminated, thereby resulting a laminated substrate. The computer system is a further configured to cause one or more articles manually separable from the laminated substrate to be defined in the laminated substrate, each article of the one or more articles having a portion of the substrate with said image of the one or more images.

In an embodiment, a mailing piece has a plastic substrate. Each image of one or More images is printed on the substrate, a different portion of the substrate per different image of the one or more images. Each image of the one or more images is provided by a user to the manufacturer of the mailing piece through at least one computer network. The plastic substrate is laminated to result in a laminated substrate and the laminated substrate is weakened along one or more contours to define one or more articles manually separable from the laminated substrate. An image of the one or more images is printed on each article of the one or more articles.

These and other features and aspects of the invention will be better understood with reference to the following description, drawings, and appended claims.

### BRIEF DESCRIPTION OF THE FIGURES

FIG. 1 illustrates selected components of a computer-based exemplary system configured in accordance with selected aspects of the present disclosure;

FIG. 2 illustrates selected steps and decision block of a process for placing, receiving, and fulfilling orders for mailing pieces with articles including user-provided information, in accordance with selected aspects of the present disclosure;

FIG. 3 illustrates selected steps of a process for manufacturing the mailing pieces;

FIG. 4A is a front view of a mailing piece with articles including user-provided images;

FIG. 4B is a back view of the mailing piece of FIG. 4A;

FIG. 4C is the front view of the mailing piece of FIGS. 4A and 4B with the articles removed; and

FIG. 4D shows front and hack views of one of the articles removed from the mailing piece of the FIGS. 4A and 4B.

### DETAILED DESCRIPTION

In this document, the words “embodiment,” “variant,” “example,” and similar expressions refer to particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar expressions and phrases are used to indicate one of a number of different possible embodiments. The number of possible embodiments is not necessarily limited to two or any to other quantity. Characterization of an item as “exemplary” means that the item is used as art example. Such characterization of an embodiment does not necessarily mean that the embodiment is a preferred embodiment; the embodiment may but need not be as currently preferred embodiment. The embodiments are described for illustration purposes and are not necessarily strictly limiting.

The words “couple,” “connect,” and similar expressions with their inflectional morphemes do not necessarily import an immediate or direct connection, but include connections through mediate elements within their meaning, unless otherwise specified or inherently required.

The word “application” includes within its meaning smartphone applications, tablet applications, and other computing, device applications.

The expression “mailing piece” refers to a flat item or card for transmission through mail or similar delivery service.

“Periphery” and “contour” mean a curve enclosing (or substantially enclosing) an article on a mailing piece.

Other and further definitions and clarifications of definitions may be found throughout this document.

Reference will now be made in detail to one or more embodiments that are illustrated in the accompanying drawings. Same reference numerals are used in the drawings and the description to refer to the same apparatus elements and method steps. The drawings are in a simplified form, not to soak, and omit elements and steps that can be added to the described systems, methods, and articles of manufacture, while possibly including certain optional elements and steps.

In selected embodiments described in this document, a user or consumer is enabled to select, create, and/or edit one or more images (pictures or other graphical information) and/or alphanumeric information to be printed on a mailing piece. The printing may be performed by any technology, including digital printers (e.g., ink jet, laser, HP Indigo digital press) and other printing means. The mailing piece is laminated and adapted for removal of one or more portions, i.e., the one or more articles. The articles may have all or some of the printed information thereon. The removable portions may be configured for attachment to other objects, such as bracelets, snaps, cords, necklaces, backpacks, shoes, keys and key chains, or other items. The mailing piece may then be sent through the postal service or another delivery service. The mailing piece may be sent to the same customer (i.e., user/consumer) who provided (selected, created, and/or edited) the information placed on the mailing piece, or another person.

The information on the mailing piece may include addressing information, such as a delivery address. In this way, the need for placing the individual custom article in pre-addressed envelopes (or addressing the envelopes after placements of the articles) is eliminated. If the mailing, piece is mailed like a postcard or in an envelope such that the address shows in the addressee window of the envelope, the mailing piece should be delivered to the customer at the correct address. This lessens the potential confusion and reduces the concern that the wrong article will be sent to the consumer, because the addressing information and the portion with other imprinted custom information (such as a picture) become part of the same mailing piece.

The mailing piece may be made of laminated plastic with one or more photographs sized to fit on various items, such as bracelets, snaps, cords, necklaces, backpacks, keys, key chains, and shoes, as mentioned above. The photographs may be captured, for example, using conventional photography and then scanned to create a digital file. The photographs (or other images) may also be captured digitally, selected from an existing set of photographs, or otherwise created. In examples, the photographs, however created or selected, are digitally edited using software such as Photoshop®. The software may include one or more filters that are pre-configured and/or are customizable by the customer. The software may also include a distorting tool (e.g., for elongating along a direction to create a distorted image), and a cropping tool.

The selection and editing of images, including filtering with pre-configured or customized filters, may be done through a website, a smartphone, or another application. The same website or application may be used for approving and ordering the customized articles with the printed images. In examples, however, a different website or applications are used for ordering. Some steps of the processes may be performed using one or more websites, while others can be used using one or more applications. Moreover, in embodiments, parts of the processes may be performed otherwise, for example, by the consumer mailing pictures and/or order form to a company.

Multiple images may be selected in a single order. The multiple images may be combined into a single image for printing on a customized article, or multiple customized articles may be created in a single order and printed on the same mailing piece. Multiple customized articles may thus be placed on the same mailing piece. The multiple customized articles may is have the same or different shapes and sizes, as is discussed in more detail below, and any combination of same or different images. For example, one, two, or three (or any number) of the articles may have the same first shape and/or size, while one, two, or three (or any number) of additional articles may have the same second shape and/or size. Similarly, one, two, or three for any number) of the articles may have the same first image printed on them, while one, two, or three (or any number) of additional articles may have the same second image printed on them.

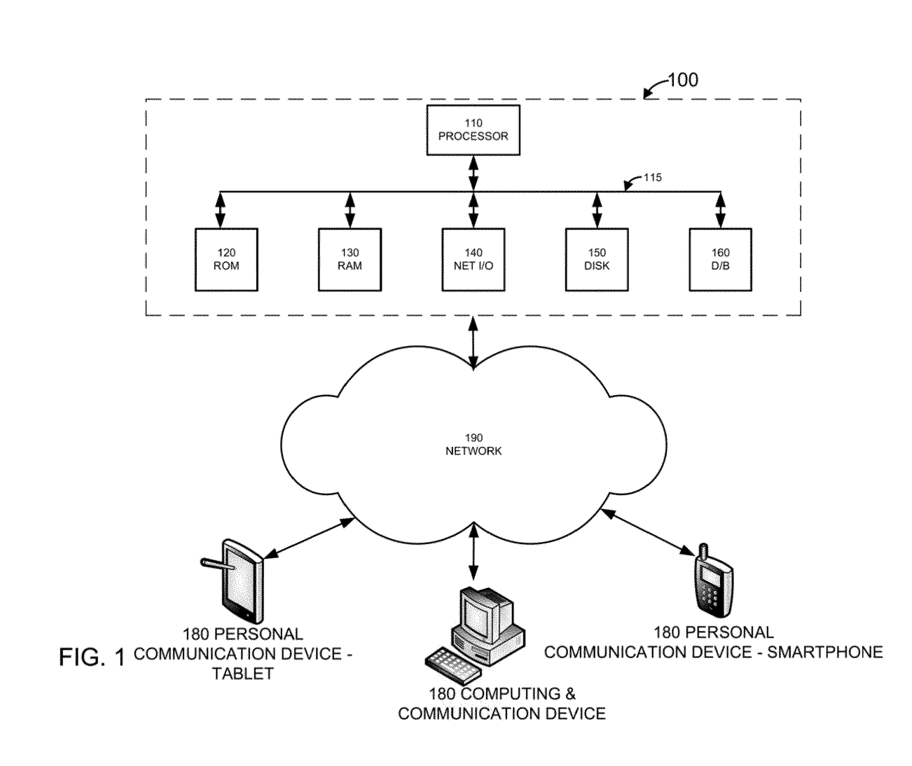

FIG. 1 is a simplified block diagram representation of a computer-based exemplary system 100 configured in accordance with selected aspects of the present disclosure. As shown in FIG. 1, the system 100 is coupled to user devices 180 via a communication network 190. FIG. 1 does not show many hardware and software modules, and omits several physical and logical connections. The system 100 can be implemented as a special purpose data processor, a general-purpose computer, a computer system, or a group of networked computers or computer systems configured to perform the steps of some methods described in this document, either alone or in conjunction with other elements such as the user devices 180. In some embodiments, the system 100 is built on a personal computer platform, such as a Wintel PC or a Mac computer. The personal computer may be a desktop or a notebook computer. The user devices 180 may be also be built on personal communication platforms, and may be or include desktop computers, laptop computers, smartphones, and tablet computers. These lists are, of course, exemplary and not necessarily exclusive.

As shown in FIG. 1, the system 100 includes a processor 110, read only memory (ROM) module 120, random access memory (RAM) module 130, network interface 140, a mass storage device 150, and a database 160. These components are coupled together by a bus 115. In the illustrated embodiment, the processor 110 is a microprocessor, and the mass storage device 150 is a magnetic disk drive. The mass storage device 150 and each of the memory modules 120 and 130 are connected to the processor 110 via the bus 115 to allow the processor 110 to write data into and read data from these storage and memory devices. The network interface 140 couples the processor 110 to the network 190, for example, the Internet. The nature of the network 190 and of the devices that may be interposed between the system 100 and the network 190 determine the kind of network interface 140 used in the system 100. In some embodiments, for example, the network interface 140 is an Ethernet interface that connects the system 100 to a local area network, which, in turn, connects to the Internet. In some embodiments, the network interface 140 is a cellular or a WiFi interface that connects the system 100 to a network, which, in turn, connects to the Internet.

The database 160 is used for organizing and storing data that may be needed or desired in performing the method steps described in this document. The database 160 may be a physically separate system coupled to the processor 110, as illustrated in FIG. 1. In some alternative embodiments, the processor 110 and the mass storage device 150 are configured to perform the functions of the database 160.

The processor 110 reads and executes program code instructions stored in the ROM module 120. Under control of the program code, the processor 110 configures the system 100 to perform all or some of the steps of the methods described below as being performed by a computing device on the server side, that is on the side that receives and fulfills the customers' orders. In addition to the RUM module 120, the program code instructions may be embodied in machine-readable storage media, such as hard drives, floppy diskettes, CD-ROMs, DVDs, and similar devices that can store the instructions permanently or temporarily, in a non-transitory manner. The program code can also be transmitted over a transmission medium, for example, over electrical wiring or cabling, through optical fiber, wirelessly, or by any other form of physical transmission. The transmission can take place over a dedicated link, between telecommunication devices, or through a wide- or local-area network, such as the Internet, an intranet, extranet, or any other kind of public or private network. In some embodiments, the program code is downloaded to the system 100 through the network interface 140.

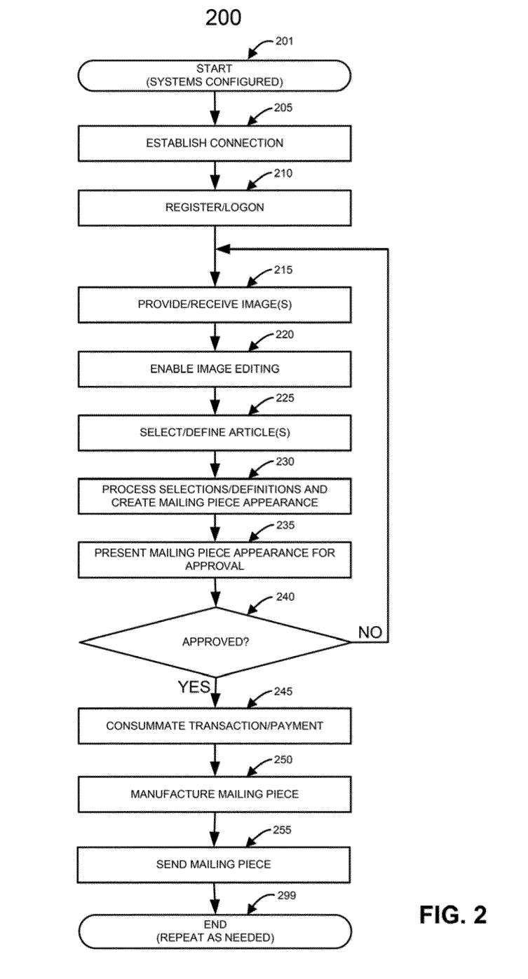

FIG. 2 is a process flow diagram illustrating selected steps and decision blocks (if applicable) of a process 200 for receiving and fulfilling an order for articles including variable user provided information. The steps/decisions of the process 200 may be performed, in whole or in part, by the system 100 of FIG. 1, for example, in communication with the user devices 180. The system 100 may be essentially a server computer, and the user device 180 a client computer. The process 200 may also be performed by various other systems.

At flow point 201, the system 100 and at least one of the user devices 180 are properly configured and ready to perform the steps of the process 200.

In step 205, a connection is established between the user device 180 of the customer and the system 100. For example, the user (i.e., a customer) visits the website of a company that receives and/or fulfills orders for the customized articles. As another example, the user activates a smartphone or other application that establishes a connection with the system 100.

In step 210, the user registers and/or logs onto the system 100. The system 100 thus knows the identity of the user, for example, for payment and product delivery purposes. In response to the user's logon, the system 100 may also provide the user with access to a list of previously ordered articles, a list of previously configured articles, and/or a list of suggested articles that the system identifies as being of potential interest to the user. The system 100 may further provide the user with access to the user's images, such as previously created, uploaded, or modified images, and other images that the system's operator may make available to the user.

In step 215, the system 100 and/or the user device 180 enable the user to provide one or more images for printing on one or more articles. For example, the user may upload images, select images stored on the database 160 or on an external database, or take pictures with the user's camera (which itself may be part of the user device 184. The user may also provide textual or other information for printing on the mailing piece.

In step 220, the system 100 and/or the user device 180 enable the user to edit the images. For example, the user can add text to the images, change an image's size (cropping), change image proportions, and apply color and other filters.

In step 225, the system 100 and/or the user device 180 enable the user to select one or more particular articles for printing of the images. As has already been mentioned, the user may be able to “create” several articles of same or different shapes and/or sizes, and with the same or different images. Note that the same image differently edited may result in effectively multiple images. For example, the user may put different text under the same image, or create different funny hoes from the same original picture of a face.

In step 230, the system 100 and/or the user device 180 process the user's selections to create or simulate an appearance of a mailing piece with the articles selected by the user. The simulated appearance includes demarcations of each of the articles in the mailing piece. As will be described in more detail below, the demarcations represent and correspond to some weakening of the material of the mailing piece, to facilitate separation of the articles from the mailing piece.

The simulated appearance of the mailing piece is presented to the user for the user's approval, in step 235.

If the user approves, as determined in decision block 240, process flow proceeds to step 245; otherwise, the process flow returns to one of the previous steps, for example, to the step 215, as shown in the Figure.

In the step 245, the transaction (purchase by the user of the mailing piece with the articles) is consummated, for example, by enabling the user to provide payment for the mailing piece, and the address for shipping the mailing piece.

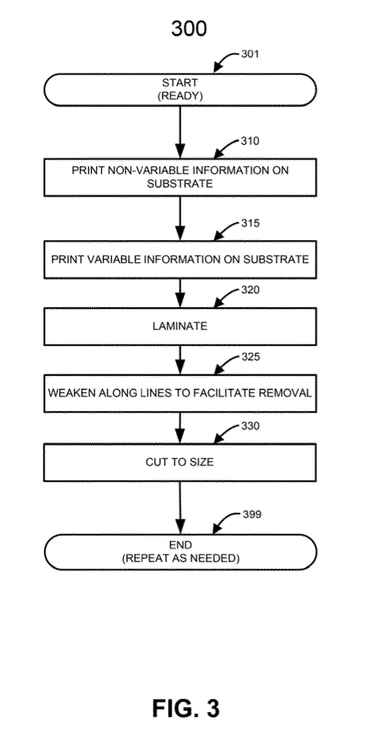

In step 250, the mailing piece with the article(s) is manufactured. This will be described in more detail below, with reference to FIG. 3.

In step 255, the mailing piece is shipped to the user or another person specified by the user. For example, the mailing piece may be mailed as a postcard, with the postage (prepaid postal indicia) printed on the mailing piece. As another example, the mailing piece is sent to the user in an envelope. The envelope may have an address window such that the delivery address printed on the mailing piece shows through the window. In this way, separate printing of addressed envelopes, with the attendant need to match the envelopes to the mailing pieces, is avoided, and the errors associated with mismatching the mailing pieces and the envelopes are reduced or eliminated. The mailing piece may be sent through the postal authority (e.g., United States Postal Service), United Parcel Service (“UPS”), Federal Express (“FedEx”), or another delivery service.

The process 200 may then terminate at flow point 299, and may be repeated for the same user or other customers, as needed.

FIG. 3 is a process flow diagram illustrating selected steps and decision blocks (if to applicable) of a process 300 for manufacturing the mailing piece. For example, the step 250 in FIG. 2 may be accomplished through the process 300.

At flow point 301, the manufacturing apparatus is ready, the required materials substrate and lamination sheets) are available, and the information needed for manufacturing the particular mailing piece such as the data obtained in all or some of the steps the steps 210-245, and possibly other data) has been obtained or determined.

In step 310, the non-variable information is printed on a sheet of substrate material. The printing may include sending by a computer system of image file(s) to a printer. The substrate material may be, for example, a plastic material, such as teslin, polyester, pvc, nylon, or another synthetic material. The non-variable information may be printed on one or both sides of the substrate. The non-variable information may include artwork, instructional, data, and promotional information. If the non-variable information is printed on both sides of the substrate, the same or different non-variable information may be printed on the different sides of the substrate. In other words, some non-variable information may be printed on one side of the substrate, while the same and/or different non-variable information may be printed on the other side of the substrate.

In step 315, variable or order-specific information is printed on the substrate. Again, the printing may include sending by a computer system of image file(s) to a printer, which may be the same printer as in the step 310 above, or as different printer. The variable information may be printed on either side of the substrate, or on both sides of the substrate. If the variable information is printed on both sides of the substrate, the same or different variable information may be printed on the different sides of the substrate. In other words, some variable information may be printed on one side of the substrate, while the same and/or different variable information may be printed on the other side of the substrate. The variable information may include the image(s) selected and processed in the process 200 of FIG. 2, information about the images (such as name of the person in the image, location, date, event), as well as other information that may be specific to the customer or the customer's order. A code, such as a barcode, that includes (or points to) information specific to the mailing piece or specific to the order may also be printed as part of the variable information. The code may be scanned during the production/mailing cycle to track production and mailing of each mailing piece. It may also be used for various other purposes, such as carrying (or pointing to) medical information, personal history, biometric information, and information needed to take advantage of a promotional offering (e.g., a discount offering from a store, a restaurant, or another retail establishment) tied to the mailing piece. The barcode may be, for example, a Universal Product Code (UPC), or a matrix code, such as a Quick Response (QR) code.

Several bar and other codes can be printed on one or both sides of the same mailing piece.

In step 320, the substrate is laminated, thereby strengthening, protecting, and enhancing the mailing piece and the articles on the mailing piece. Either side or both sides of the substrate may be laminated with, for example, plastic lamination film, and equipment such as Auto Feed laminator. Heat activated polyester/polyethylene lamination may be used. The lamination film may be transparent. The laminating step may include a computer system activating a lamination machine at an appropriate time, that is, when the substrate is in or accessible to the machine.

In step 325, the laminated substrate is processed to facilitated removal of the one or more articles. For example, material along the line(s) defining the article(s) may be perforated, partially die cut, or otherwise weakened to facilitate tearing of the article(s) from the mailing piece. Many different patterns for the articles on the mailing piece are available, including, without limitation, polygonal shapes, round shapes, oblong shapes, teardrop shapes, heart-shapes, and similar shapes. This step may include a computer system activating the die cutting or perforating machine at the appropriate time.

In step 330, the substrate is cut to the desired size, for example, to the size of a standard postcard or to such size as will fit without excessive movement in a standard (e.g. letter size) envelope. In examples, the laminated substrate is die cut to 7.875″ by 3.75″ size. This step may include a computer system activating the die cutting machine at the appropriate time.

The process 300 may then terminate at flow point 399, and may be repeated for the same customer or other customers, as needed.

In examples, the order of the steps 325 and 330 is reversed. In examples, both steps 325 and 330 are effectively combined into a single step (performed substantially concurrently).

In examples, the order of the steps 310 and 315 is reversed. In examples, both steps 310 and 315 are effectively combined into a single step (performed substantially concurrently).

The mailing piece (e.g., the printed, laminated, perforated, and die cut substrate) may thus have one or multiple images imprinted and surrounded by perforation, partial die cutting, or other material weakening lines, in various shapes and sizes. Additionally, one or more magnetic strips may be placed on the mailing piece and/or one or more of the articles. The magnetic strips may be encoded with information, such as account number(s), balance(s), and other variable and/or non-variable information.

In embodiments, the articles include loyalty cards, identification cards, and membership cards.

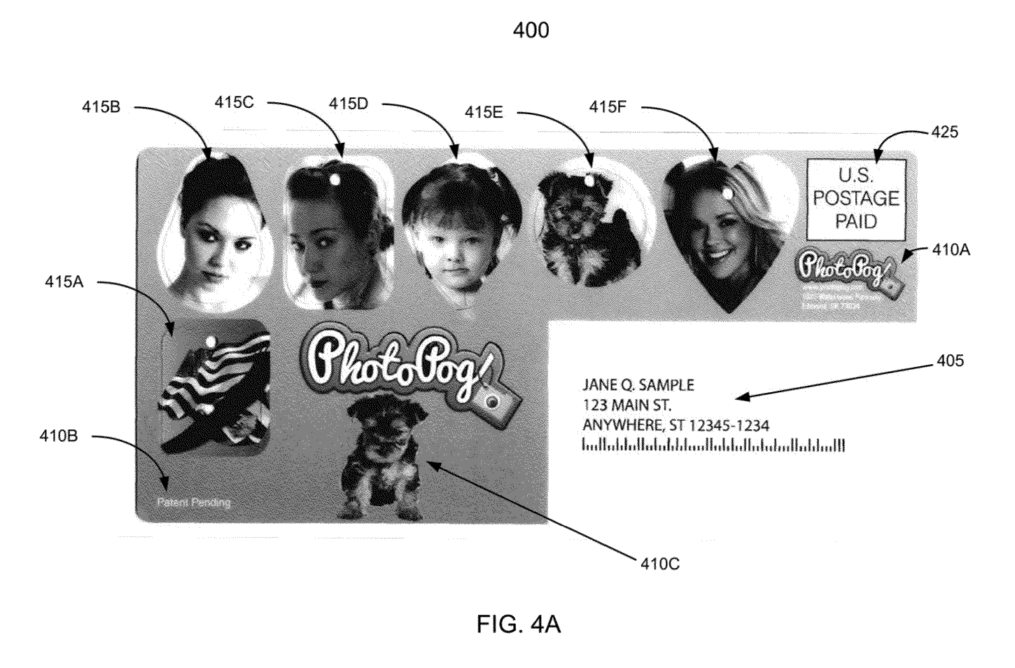

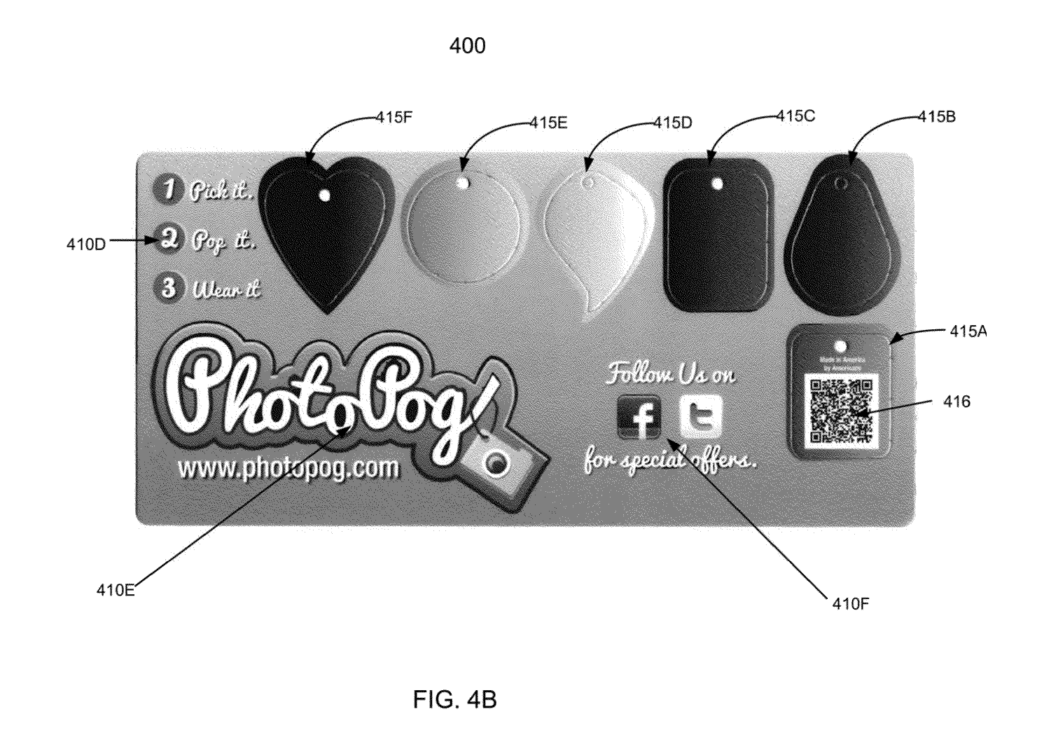

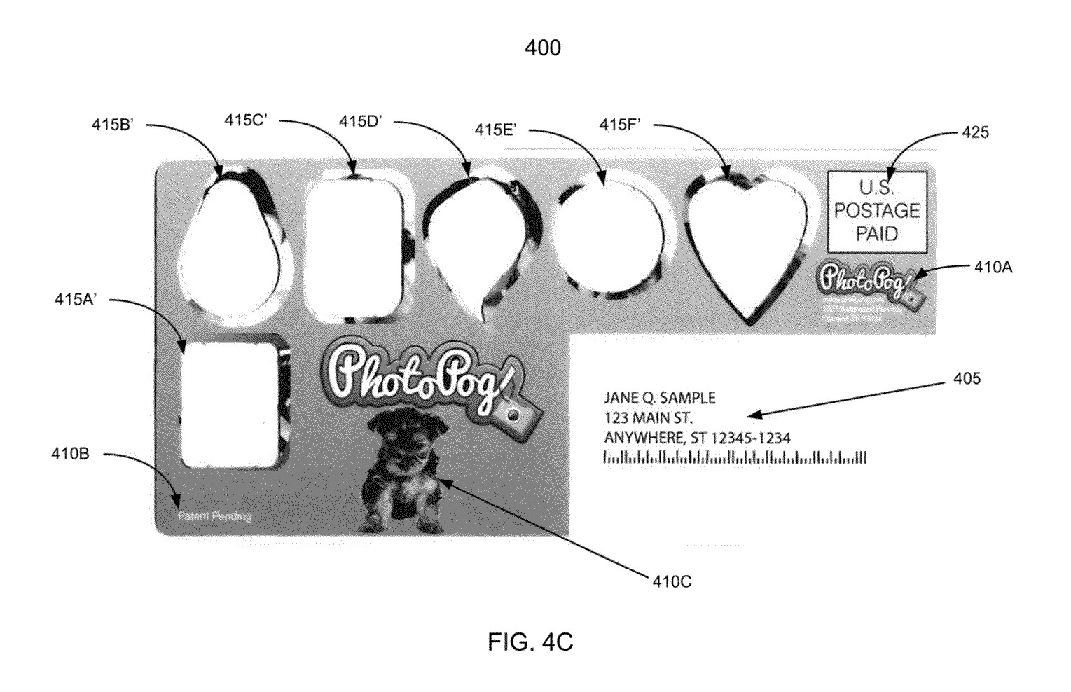

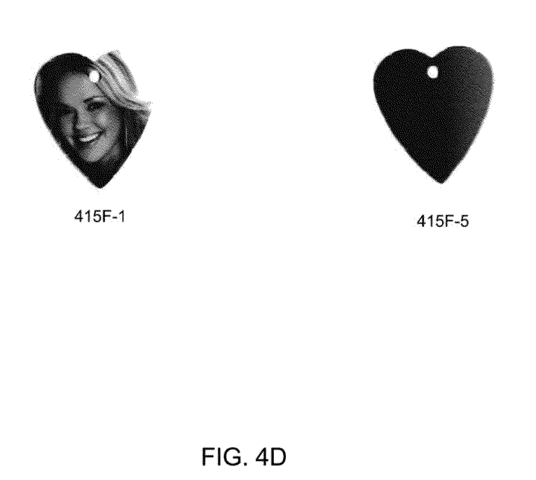

FIG. 4A is a front (obverse) view of an example of a mailing piece 400. Note the printed delivery address information 405, postage 425, non-variable information 410A through 410C, and the articles 415A through 415F with their surrounding perforation. If desired, a magnetic strip could be deposed on the article 400, for example, above the non-variable information 41013.

FIG. 4B is a back (reverse) view of the exemplary mailing piece 400. Note the presence of additional non-variable information 4101) through 410F, and a QR code 416 on the back side of the article 415A.

FIG. 4C is the front view of the mailing piece 400 alter the articles 415A through 415F have been removed along their respective perforations, leaving openings 415A′ through 415F′.

FIG. 4D illustrates the article 415F removed from the mailing piece 400. In the Figure, 415F-1 designates the front of the article 415F, while 415F-2 designates the hack of the article 415F. Note a hole in the middle upper portion of the article 415F, which can be used to loop a string through the article, for attaching the article to another object, such as a necklace. The hole may be created by removing a small round portion created as part of the step 325.

Although the process steps and decisions (if decision blocks are present) may be described serially in this document, certain steps and/or decisions may be performed by separate elements in conjunction or in parallel, asynchronously or synchronously, in a pipelined manner, or otherwise. There is no particular requirement that the steps and decisions be performed in the same order in which this description lists them or the Figures show them, except where a specific order is inherently required, explicitly indicated, or is otherwise made clear from the context. Furthermore, not every illustrated step and decision block may be required in every embodiment in accordance with the concepts described in this document, while some steps and decision blocks that have not been specifically illustrated may be desirable or necessary in some embodiments in accordance with the concepts. It should be noted, however, that specific embodiments/variants/examples use the particular order(s) in which the steps and decisions (if applicable) are shown and/or described.

This document describes in detail the inventive mailing pieces with articles fabricated on them, as well, as apparatus and methods for fabricating the mailing pieces. This was done for illustration purposes. Neither the specific embodiments, nor their features necessarily limit the general principles underlying the disclosure of this document. The specific features described herein may be used in some embodiments, but not in others, without departure from the spirit and scope of the invention as set forth herein. Various physical arrangements of components or elements, and various step sequences also fill within the intended scope of the invention. Many additional modifications are intended in the foregoing disclosure, and it will be appreciated by those of ordinary skill in the art that in some instances some features of will be employed in the absence of a corresponding use of other features. The illustrative examples therefore do not define the metes and bounds of the invention and the legal protection afforded the invention, which function may be carried out by current and future claims and their equivalents.

I claim:

1. A method for providing a mailing piece, the method comprising steps of:
obtaining from a user information sufficient to get one or more images in digital form;
printing each image of the one or more images on a plastic substrate, a different portion of the substrate per different image of the one or more images, thereby obtaining a printed substrate;
laminating the printed substrate, thereby obtaining a laminated substrate;
defining in the laminated substrate one or more articles manually separable from the laminated substrate, each article of the one or more articles having a portion of the substrate with said image of the one or more images.

2. A method according to claim 1, wherein the step of defining comprises weakening the laminated substrate along a periphery of the one or more articles.

3. A method according to claim 2, wherein the step of weakening comprises perforating the laminated substrate along the periphery.

4. A method according to claim 2, wherein the step of weakening comprises partially die cutting the laminated substrate along the periphery.

5. A method according to claim 2, wherein the step of obtaining comprises receiving from the user the information through least one computer network.

6. A method according to claim 5, wherein the at least one computer network comprises the Internet.

7. A method according to claim 2, wherein the step of obtaining comprises receiving from the user the one or more images through at least one computer network.

8. A method according to claim 2, wherein the step of obtaining comprises receiving from the user one or more image files through at least one computer network, and editing the one or nor image files to result in the one or more images.

9. A method according to claim 2, wherein the step of Obtaining comprises receiving from the user the one or images through at least one computer network, and enabling the user to edit the one or more images online.

10. A method according to claim 2, further comprising printing on the substrate a bar code before the step of laminating.

11. A method according to claim 2, further comprising printing at the substrate a promotional offering before the step of laminating.

12. A method according to claim 2, further comprising printing on the substrate delivery address for the mailing piece.

13. A method according to claim 2, further comprising printing on the substrate prepaid postal indicia.

14. A method according to claim 2, wherein the step of defining comprises creating in at least one article of the one or more articles means for attaching the at least one of the one or more articles to an object other than the mailing piece.

15. A method according to claim 2, further comprising sending the mailing piece through a delivery service.

16. A method according to claim 2, further comprising:
causing an appearance of the mailing piece to be displayed to the user; and
obtaining from the user an approval of the mailing piece;
wherein the step of obtaining from the user the approval is performed after the step if causing the appearance to be displayed and before the step of printing.

17. A method according to claim 16, further comprising receiving from the user payment authorization for the mailing piece.

18. A method according to claim 17, wherein:
the step of obtaining comprises receiving from the user the information through at least one computer network; and
the steps of causing the appearance of the mailing piece to be displayed, obtaining from the user the approval, and receiving from the user payment authorization are performed through the at least one computer network.

19. A computer system configured to obtain from a user in information sufficient to get one or inure images; cause each image of the one or more images to be printed on a plastic substrate, a different portion of the substrate per different image, thereby resulting in a printed substrate; cause the printed substrate to be laminated, thereby resulting a laminated substrate; and cause one or more articles manually separable from the laminated substrate to be defined in the laminated substrate, each article of the one or more articles having a portion of the substrate with said image of the one or more images.

20. A mailing piece comprising a plastic substrate, wherein each image of one or more images is printed on the substrate, a different portion of the substrate per different image of the one or more images, said each image of the one or more images having been provided by a user to manufacturer of the mailing piece through at least one computer network, the plastic substrate being laminated to result in a laminated substrate, the laminated substrate being weakened along one or more contours to define one or more articles manually separable from the laminated substrate, an image of the one or more images being printed on each article of the one or more articles.
